(19) United States
(12) Patent Application Publication
(10) Pub. No.: US 2015/0340161 A1
(43) Pub. Date: Nov. 26, 2015

(54) PASSIVE COMPONENT AND METHOD FOR MAKING THE SAME AND METHOD FOR MAKING A LEAD THEREOF

(71) Applicant: ZONKAS ELECTRONIC CO., LTD., Taichung City (TW)

(72) Inventor: SHIH-CHI WENG, Taichung City (TW)

(73) Assignee: ZONKAS ELECTRONIC CO., LTD., Taichung City (TW)

(21) Appl. No.: 14/283,474

(22) Filed: May 21, 2014

(51) Int. Cl. H01G 9/048; H01G 9/00; H01G 9/08

(52) U.S. Cl. CPC H01G 9/048; H01G 9/08; H01G 9/0029

(57) ABSTRACT

A passive component and method for making the same and method for making a lead thereof are provided. The passive component produced includes two thinned flat leads which are substantially parallel to the bottom surface of the passive component. Whereby, the passive component is easy to rest vertically on a surface without any additional aid, and convenient and quick for connection to a circuit; the passive component can has small volume, the area for wielding and contact to an electrode is increased, and the electric conduction is improved and the electric resistance is lowered; it is easy to manufacture and low-cost, and the passive component can be produced with mass production.

### BACKGROUND OF THE INVENTION

1. Field of the Invention

The present invention relates to a passive component, and particularly to a passive component and a method for making the same and a method for making a lead thereof.

2. Description of the Prior Art

Generally, well-known passive components such as capacitor, resistor and inductor are used in devices which are electrically driven. Passive components are arranged in various circuits to function differently, applying to various fields such as electronic industry and other industry, and they are very important components.

A conventional passive component generally includes two leads extending vertically from the bottom side thereof, wherein the two leads are for insertion into holes such as formed on a PCB substrate, and the conventional passive component is then electrically connected with the PCB substrate by soldering. For example, TW I434306, TW M472299 and TW I425540 respectively disclose this conventional kind of passive component.

However, a conventional PCB substrate is provided with a complex circuit construction with a great quantity of holes for insertion of the passive components, and thus it requires much time and work. Besides, during process of electrically connecting the passive component, since the two leads cannot positionably stand on the by itself, so that it requires additional assistance to hold the passive component, the two leads are hidden under the bottom side of the passive component and therefore disadvantages the mounting of the passive component, thus the mounting (such as soldering) of the passive component is not quick and inconvenient.

Additionally, electronic product is made in smaller and smaller dimensions, so the passive component is made in smaller and smaller dimensions accordingly. However, the structure of the conventional passive component above-mentioned and the electrically-connected insertion cause a great thickness and a large volume.

The present invention is, therefore, arisen to obviate or at least mitigate the above mentioned disadvantages.

### SUMMARY OF THE INVENTION

An object of the present invention is to provide a passive component and a method for making the same and a method for making a lead thereof, in which the passive component is easy to rest on a circuit construction due to two flat sections, the passive component can be adhered or attached to the circuit construction quickly and firmly; the entire size can be reduced; the conduction can be enhanced and the resistance can be reduced; it is very simple, of low cost and can be manufactured in mass production.

To achieve the above and other objects, a method for making a lead of a passive component is provided. The passive component includes a passive component main body and a first electrode and a second electrode which are located respectively at corresponding first side and second side of the passive component main body. The method includes steps of: providing at least one first conductive wire, each first conductive wire having a first connection section, a bent section and a first lead section sequentially; bending and flatting each first conductive wire, the first lead section flatted to form a first flat section, the first flat section including a first plane for facingly attached to a circuit construction, each bent section of each bent first conductive wire being traverse to the first connection section, each first flat section of each bent first conductive wire being traverse to the bent section; wherein when the first connection section is electrically connected with the first electrode, the bent section extends along a circumferential side of the passive component main body, the first flat section is located at the second side and extends substantially parallel to the second side, and the first plane and the second side face substantially toward the same direction.

To achieve the above and other objects, a method for making a passive component is provided. The method includes steps of: providing at least one first conductive wire, each first conductive wire having a first connection section, a bent section and a first lead section sequentially; providing at least one second conductive wire, each second conductive wire having a second connection section and a second lead section; bending each first conductive wire and flatting each first and second conductive wires, the first and second lead sections respectively flatted to form a first flat section and a second flat section, the first and second flat sections respectively including a first plane and a second plane for facingly attached to a circuit construction, each bent section of each bent first conductive wire being traverse to the first connection section, each first flat section of each bent first conductive wire being traverse to the bent section, each second connection section of each second conductive wire and the second flat section extending substantially straightly; providing at least one passive component main body, each passive component main body including a first electrode and a second electrode which are located at corresponding first side and a second side; electrically connecting the first and second connection sections respectively to the first and second electrodes, so that the bent section extends along a circumferential side of the passive component main body, the first and second flat sections are located at the second side and substantially extend parallel to the second side, and the first and second planes and the second side face substantially toward the same direction.

To achieve the above and other objects, a passive component is provided. The passive component includes a passive component main body, a first conductive wire and a second conductive wire. The passive component main body includes a first electrode and a second electrode located at corresponding first side and second side. The first conductive wire sequentially has a first connection section, a bent section and a first flat section. The first flat section includes a first plane for facingly attached to a circuit construction. The first connection section is electrically connected with the first electrode, and the bent section extends along a circumferential side of the passive component main body. The first flat section is located at the second side and extends substantially parallel to the second side, and the first plane and the second side face substantially toward the same direction. The second conductive wire sequentially has a second connection section and a second flat section, and the second connection section and the second flat section extend substantially straightly. The second flat section includes a second plane for facingly attached to the circuit construction, and the second connection section is electrically connected with the second electrode. The second flat section is located at the second side and extends substantially parallel to the second side, and the second plane and the second side face substantially toward the same direction.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIGS. 1-7 drawings showing a method for making a passive component according to a preferred embodiment of the present invention;

FIG. 8 is a perspective view of a passive component according to a preferred embodiment of the present invention;

FIG. 9 is a perspective view of a passive component according to an alternative preferred embodiment of the present invention; and

FIG. 10 is a perspective view of a passive component according to another preferred embodiment of the present invention

### DETAILED DESCRIPTION OF THE PREFERRED EMBODIMENTS

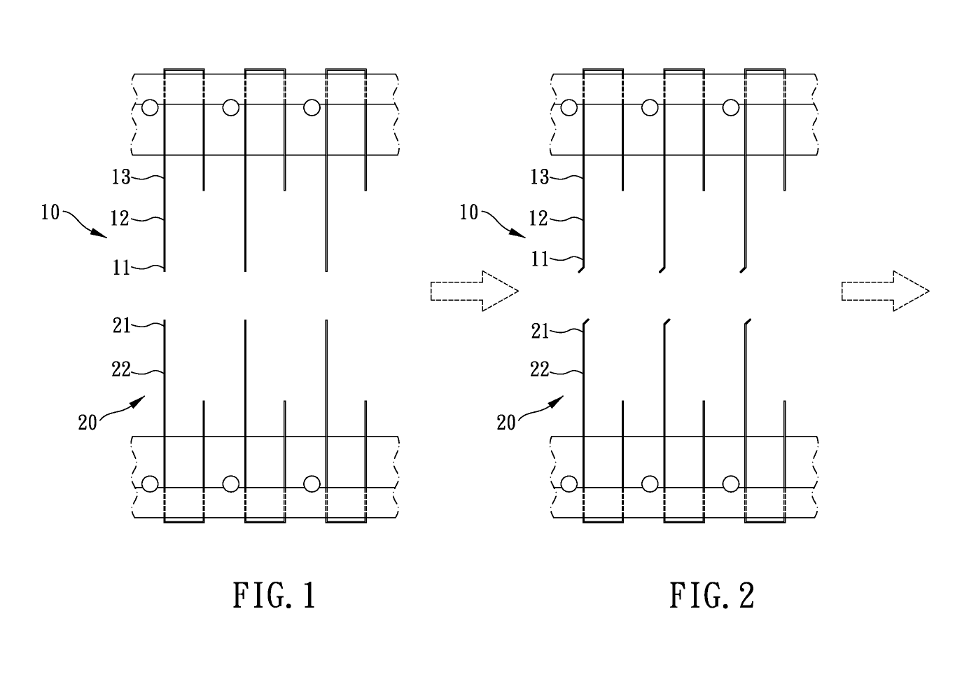

FIGS. 1 to 7 show a preferred embodiment of the present invention. A method for making a passive component may be used to manufacture a device such as capacitor, resistor, inductor, resistance-capacitance device or surge absorber. The method for making a passive component is described below in detail.

As shown in FIG. 1, at least one first conductive wire 10 is provided. Each first conductive wire 10 sequentially has a first connection section 11, a bent section 12 and a first lead section 13. Specifically, a plurality of the first conductive wires 10 are fixed (such as adhered or pressed) on a manufacturing machine. Each first conductive wire 10 is substantially U-shaped and has a long leg and a short leg, wherein the long leg is provided with the first connection section 11, the bent section 12 and the first lead section 13.

At least one second conductive wire 20 is provided. Each second conductive wire 20 sequentially has a second connection section 21 and a second lead section 22. Specifically, a plurality of the second conductive wires 20 are fixed on the manufacturing machine. Each second conductive wire 20 is substantially U-shaped and has a long leg and a short leg, wherein the long leg is provided with the second connection section 21 and the second lead section 22.

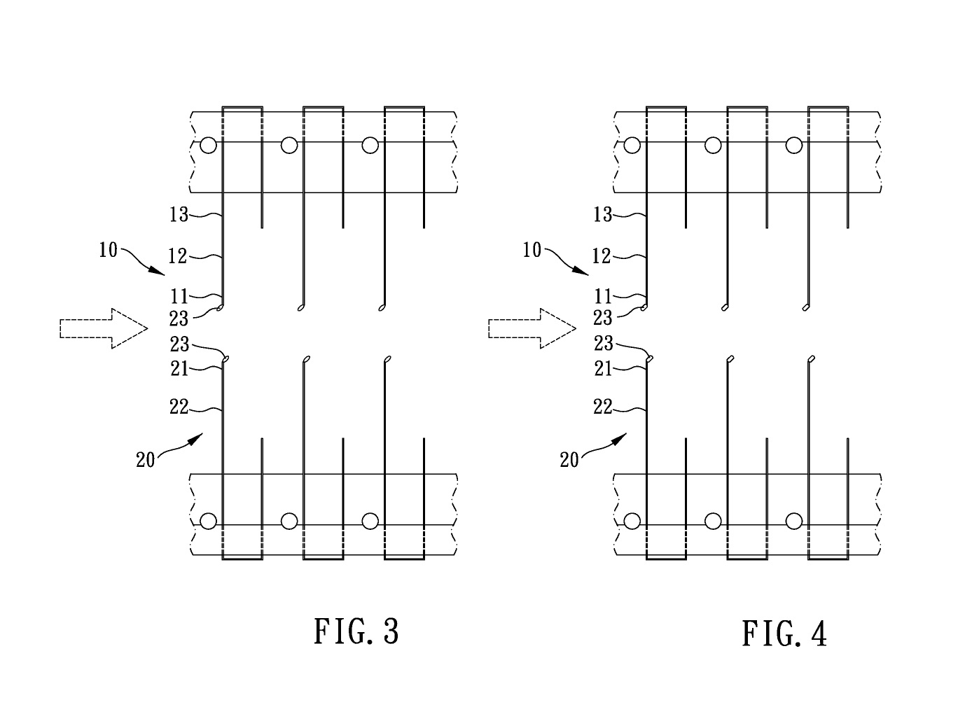

As shown in FIGS. 2-4, ends of each first and second connection sections 11, 21 are bent (FIG. 2) and then adhered with soldering paste 23 (such as tin soldering paste, FIG. 3) and flatted (FIG. 4). To bend the ends of each first and second connection sections 11, 21 can facilitate adherence of the soldering paste 23, and the following flatting can increase attachment area to facilitate attachment with other member(s). It is noted that in this stage the bending and flatting steps are optional and may be omitted.

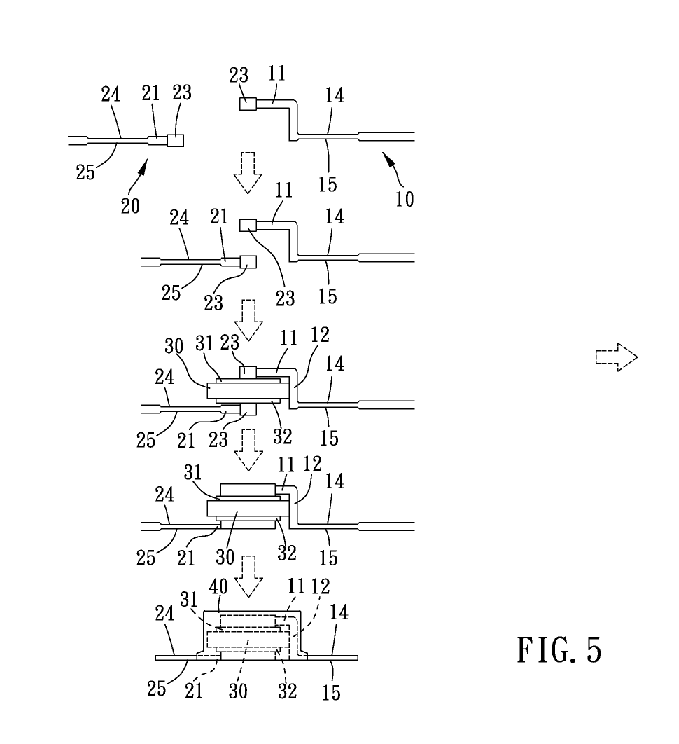

As shown in FIGS. 4 and 5, each first conductive wire 10 is bent and each first and second conductive wires 10, 20 are flatted. The first and second lead sections 13, 22 are respectively flatted to form a first flat section 14 and a second flat section 24. The first and second flat sections 14, 24 respectively include a first plane 15 and a second plane 25 for facingly attached to a circuit construction (not shown). Each bent section 12 of each bent first conductive wire 10 is traverse to the first connection section 11, each first flat section 14 of each bent first conductive wire 10 is traverse to the bent section 12, and each second connection section 21 of each second conductive wire 20 and the second flat section 24 extend substantially straightly. Specifically, distal ends of the first flat section 14 and the second flat section 24 are substantially parallel to the first and second connection sections 11, 21. The process of bending each first conductive wire 10 and flatting each first and second conductive wires 10, 20 includes steps of: bending each first conductive wire, so that each bent section 12 of each first conductive wire 10 is traverse to the first connection section 11 and each first lead section 13 of each first conductive wire 10 is traverse to the bent section 12; and flatting each first and second lead sections 13, 22 to respectively form each first and second flat sections 14, 24.

Each first connection section 11 and one the second connection section 21 are correspondingly spaced. Preferably, each flatted end of each first connection section 11 corresponds and is parallel to one flatted end of the second connection section 21. Ends of each first connection section 11 and each second connection section 21 are adhered with flux to facilitate the following soldering process. However, the step of adherence of the flux may be omitted.

As shown in FIG. 5, at least one passive component main body 30 is provided. Each passive component main body 30 includes a first electrode 31 and a second electrode 32 located at corresponding first side and second side. Specifically, a plurality of the passive component main body 30 are respectively disposed between every corresponding first connection section 11 and second connection section 21, and every corresponding first connection section 11 and second connection section 21 correspond respectively to one the first electrode 31 and one the second electrode 32.

Each first and second connection sections 11, 21 are respectively electrically connected with the first and second electrodes 31, 32 (preferably, the first and second connection sections 11, 21 are flat and respectively attached to the first and second electrodes 31, 32), using soldering or other suitable ways to melt the soldering paste to electrically connected each first and second connection sections 11, 21 respectively to the first and second electrodes 31, 32. The bent section 12 extends along a circumferential side of the passive component main body 30, the first and second flat sections 14, 24 are located at the second side and substantially parallel to the second side, and the first and second planes 15, 25 and the second side face substantially toward the same direction. Preferably, the first and second flat sections 14, 24 and the second side are located substantially at the same plane.

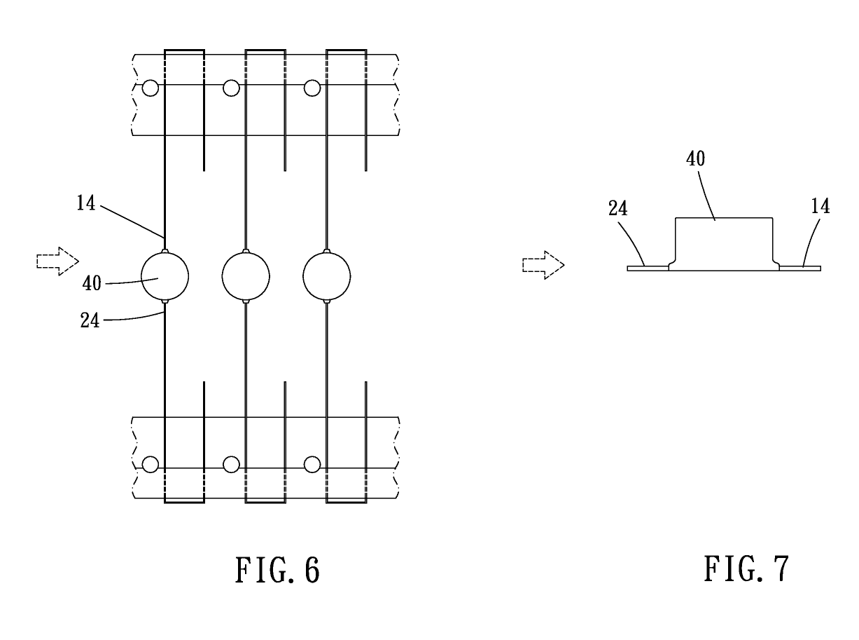

As shown in FIGS. 5 and 6, preferably, after each first and second connection sections 11, 21 are respectively electrically connected to corresponding first and second electrodes 31, 32, an insulating material 40 further encapsulates corresponding passive component main body 30. Each first and second flat sections 14, 24 are at least partially exposed outside the insulating material 40. The encapsulating process may include steps of: disposing of mold; filling of the insulating material 40; vibrating and rotating et al., but is not limited thereto.

As shown in FIG. 7, each first and second flat sections 14, 24 are cut at predetermined positions so that a plurality of the passive components are completed. The passive component may be further packaged or proceed with other procedures.

It is noted that, the structure of the present invention may be designed according to various requirements. For example, The process of bending each first conductive wire 10 and flatting each first and second conductive wires 10, 20 may be proceed with steps of: flatting each first and second lead sections 13, 22 to respectively form each first and second flat sections 14, 24; then bending each first conductive wire 10, so that each bent section 12 of each first conductive wire 10 is traverse to the first connection section 11 and each first flat section 14 of each first conductive wire 10 is traverse to the bent section 12. Additionally, the process of bending each first conductive wire 10 and flatting each first and second conductive wires 10, 20 may be carried out after the step of encapsulating the insulating material 40.

As shown in FIGS. 1-5, a method for making a lead of a passive component is further provided. The method for making a lead includes steps of: providing at least one first conductive wire 10, each first conductive wire 10 sequentially having a first connection section 11, a bent section 12 and a first lead section 13; bending and flatting each first conductive wire 10, wherein the first lead section 13 is flatted to form a first flat section 14, the first flat section 14 includes a first plane 15 for facingly attached to a circuit construction, each bent section 12 of each bent first conductive wire 10 is traverse to the first connection section 11, each first flat section 14 of each bent first conductive wire 10 is traverse to the bent section 12; wherein when the first connection section 11 is electrically connected with the first electrode 31, the bent section 12 extends along a circumferential side of the passive component main body 30, the first flat section 14 is located at the second side and substantially parallel to and along the second side, the first plane 15 and the second side face substantially toward the same direction. In the method for making a lead of a passive component, it may be optional to bend each first conductive wire 10 first and then to carry out the flatting step; however, it may be optional to flat each first lead section 13 first and then to bend each first conductive wire 10.

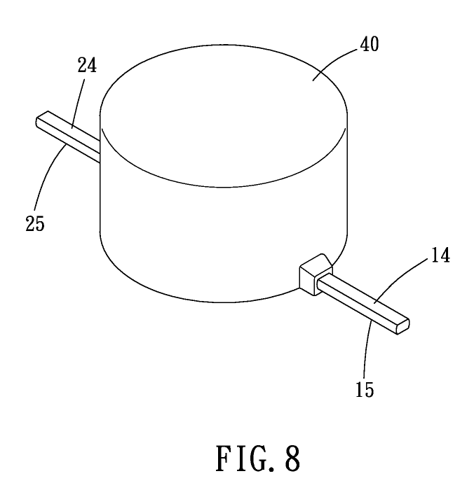

As shown in FIGS. 5, 7 and 8, a passive component is further provided. The passive component includes a passive component main body 30, a first conductive wire 10 and a second conductive wire 20. The passive component main body 30 includes a first electrode 31 and a second electrode 32 located at corresponding first side and second side. The first conductive wire 10 sequentially has a first connection section 11, a bent section 12 and a first flat section 14. The first flat section 14 includes a first plane 15 for facingly attached to a circuit construction. The first connection section 11 is electrically connected with the first electrode 31, and the bent section 12 extends along a circumferential side of the passive component main body 30. The first flat section 14 is located at the second side and substantially parallel to and extends along the second side. The first plane 15 and the second side face toward substantially the same direction. The second conductive wire 20 sequentially has a second connection section 21 and a second flat section 24, and the second connection section 21 and the second flat section 24 extend substantially straightly. The second flat section 24 includes a second plane 25 for facingly attached to the circuit construction. The second connection section 21 is electrically connected with the second electrode 32, the second flat section 24 is located at the second side and substantially parallel to and extend along the second side. The second plane 25 and the second side face substantially toward the same direction. Preferably, an insulating material 40 encapsulates the passive component main body 30, and the first and second flat sections 14, 24 are at least partially exposed outside the insulating material 40 respectively.

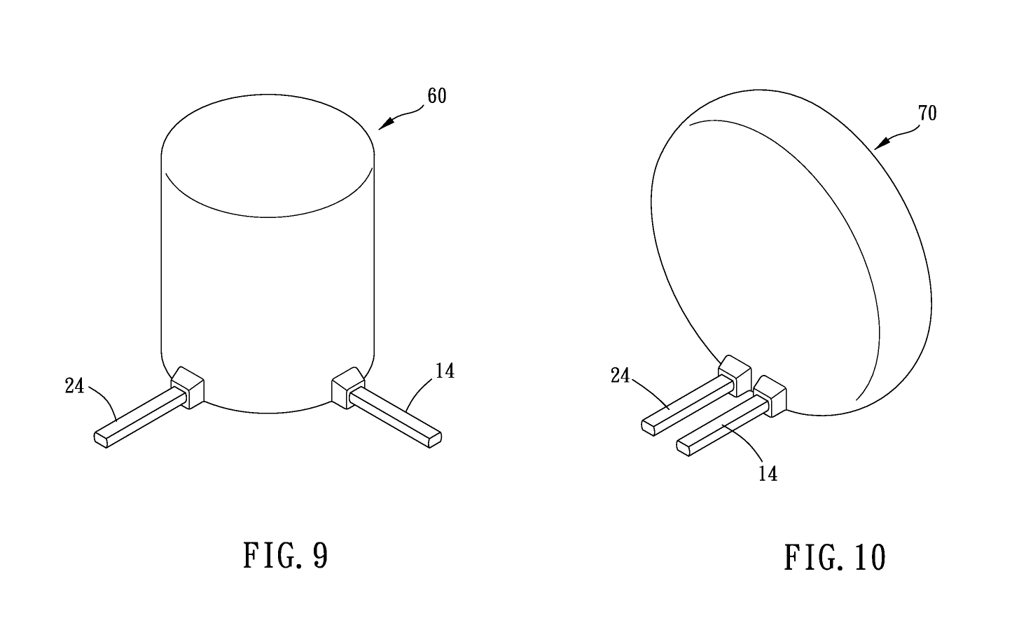

According to various requirements, in other embodiments, a passive component 60 may be constructed to be cylindrical (such as an electrolytic capacitor, as shown in FIG. 9), or a passive component 70 may be constructed to be bean-shaped (such as a ceramic capacitor, as shown in FIG. 10); first and second flat sections 14, 24 may be constructed to be orthogonal to each other (as shown in FIG. 9), or extend toward the same direction in parallel (as shown in FIG. 10), or in any suitable configuration.

Given the above, the method of the present invention can produce a passive component having two flat sections facing in the same direction toward a plane to which the two flat sections are going to be attached, thus facilitating standing of the passive component. During that the passive component is adhered or attached to a circuit construction, and the passive component can be mounted without any additional holding. Furthermore, since the two flat sections extend beyond the contour of the passive component main body, it is easy to align the two flat sections with the conductive pads or the like on the circuit construction without being interfered by the passive component main body, thus advantaging the mounting of the passive component.

In addition, the passive component has the two flat sections generally parallel to the bottom side thereof but not perpendicular to the bottom side (such as a conventional structure), and the entire size can be reduced.

Moreover, since the two flat sections can increase areas for electrical connection and contact with corresponding conductive pads or the like on the circuit construction, it advantages the attachment of the two flat sections to corresponding conductive pads or the like quickly and firmly and the conduction can be enhanced (the resistance can be reduced).

Besides, the method for making a lead of a passive component, the method for making a passive component and the passive component is very simple, of low cost and can be manufactured in mass production.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A method for making a lead of a passive component, the passive component including a passive component main body and a first electrode and a second electrode which are located respectively at corresponding first side and second side of the passive component main body, the method including steps of:
providing at least one first conductive wire, each first conductive wire having a first connection section, a bent section and a first lead section sequentially;
bending and flatting each first conductive wire, the first lead section flatted to form a first flat section, the first flat section including a first plane for facingly attached to a circuit construction, each bent section of each bent first conductive wire being traverse to the first connection section, each first flat section of each bent first conductive wire being traverse to the bent section;
wherein when the first connection section is electrically connected with the first electrode, the bent section extends along a circumferential side of the passive component main body, the first flat section is located at the second side and extends substantially parallel to the second side, and the first plane and the second side face substantially toward the same direction.

2. The method for making a lead of a passive component of claim 1, wherein the process of bending and flatting each first conductive wire includes steps of:
bending each first conductive wire, so that each bent section of each first conductive wire is traverse to the first connection section, and each first lead section of each first conductive wire is traverse to the bent section;
flatting each first lead section to form each first flat section.

3. The method for making a lead of a passive component of claim 1, wherein the process of bending and flatting each first conductive wire includes steps of:
flatting each first lead section to form each first flat section;
bending each first conductive wire, so that each bent section of each first conductive wire is traverse to the first connection section and each first flat section of each first conductive wire is traverse to the bent section.

4. A method for making a passive component, including steps of:
providing at least one first conductive wire, each first conductive wire having a first connection section, a bent section and a first lead section sequentially;
providing at least one second conductive wire, each second conductive wire having a second connection section and a second lead section;
bending each first conductive wire and flatting each first and second conductive wires, the first and second lead sections respectively flatted to form a first flat section and a second flat section, the first and second flat sections respectively including a first plane and a second plane for facingly attached to a circuit construction, each bent section of each bent first conductive wire being traverse to the first connection section, each first flat section of each bent first conductive wire being traverse to the bent section, each second connection section of each second conductive wire and the second flat section extending substantially straightly;
providing at least one passive component main body, each passive component main body including a first electrode and a second electrode which are located at corresponding first side and a second side;
electrically connecting the first and second connection sections respectively to the first and second electrodes, so that the bent section extends along a circumferential side of the passive component main body, the first and second flat sections are located at the second side and substantially extend parallel to the second side, and the first and second planes and the second side face substantially toward the same direction.

5. The method for making a passive component of claim 4, wherein the process of bending each first conductive wire and flatting each first and second conductive wires includes steps of:
bending each first conductive wire, so that each bent section of each first conductive wire is traverse to the first connection section and each first lead section of each first conductive wire is traverse to the bent section;
flatting each first and second lead sections to form each first and second flat sections.

6. The method for making a passive component of claim 4, wherein the process of bending each first conductive wire and flatting each first and second conductive wires includes steps of:
flatting each first and second lead sections to form each first and second flat sections;
bending each first conductive wire, so that each bent of each section first conductive wire is traverse to the first connection section and each first flat section of each first conductive wire is traverse to the bent section.

7. The method for making a passive component of claim 4, wherein after each first and second connection sections are respectively electrically connected to corresponding first and second electrodes, an insulating material further encapsulates corresponding passive component main body, and each first and second flat sections are at least partially exposed outside the insulating material.

8. A passive component, including:
a passive component main body, including a first electrode and a second electrode located at corresponding first side and second side;
a first conductive wire, sequentially having a first connection section, a bent section and a first flat section, the first flat section including a first plane for facingly attached to a circuit construction, the first connection section electrically connected with the first electrode, the bent section extending along a circumferential side of the passive component main body, the first flat section being located at the second side and extending substantially parallel to the second side, and the first plane and the second side facing substantially toward the same direction;
a second conductive wire, sequentially having a second connection section and a second flat section, the second connection section and the second flat section extending substantially straightly, the second flat section including a second plane for facingly attached to the circuit construction, the second connection section electrically connected with the second electrode, the second flat section located at the second side and extending substantially parallel to the second side, and the second plane and the second side facing substantially toward the same direction.

9. The passive component of claim 8, further including an insulating material encapsulating the passive component main body, wherein the first and second flat sections are at least partially exposed outside the insulating material.

10. The passive component of claim 8, wherein the first and second connection sections are flat and respectively attached to the first and second electrodes.
